(19) United States
(12) Patent Application Publication
(10) Pub. No.: US 2004/0142136 A1
(43) Pub. Date: Jul. 22, 2004

(54) High temperature resistant films and adhesive articles made therefrom

(76) Inventor: Keith Lawson Truog, Crown Point, IN (US)

Correspondence Address: Heidi A. Boehlefeld, Renner, Otto, Boisselle & Sklar, LLP, Nineteenth Floor, 1621 Euclid Avenue, Cleveland, OH, 44115-2191, US

(21) Appl. No.: 10/740,997

(22) Filed: Dec. 19, 2003

Related U.S. Application Data
(60) Provisional application No. 60/438,604, filed on Jan. 7, 2003.

(51) Int. Cl. B32B 9/00

(52) U.S. Cl. 428/40.1

(57) ABSTRACT

High temperature resistant films and labels comprising a polyvinylidene fluoride polymer facestock and a print receptive layer on its surface. The high temperature resistant films and labels are particularly suitable for use in printed circuit board manufacturing processes.

This application claims the benefit of Provisional Application Serial No. 60/438,604 filed Jan. 7, 2003.

### TECHNICAL FIELD

The present invention relates to thermally stable adhesive articles, and more particularly, to labels and tapes suitable for high temperature applications. The labels and tapes of the present invention are suitable for use under conditions of high temperature and harsh chemical environments encountered in printed circuit board manufacturing processes.

### BACKGROUND OF THE INVENTION

Surface mount processing of printed circuit boards is advantageous because of its emphasis on efficiency of manufacturing and automation. To enable circuit board manufacturers to track each board through the course of the automated manufacturing process, bar code labels are applied to the green or “raw” boards at the beginning of the manufacturing process. The manufacturer is able to maintain quality control by scanning a board's unique bar code and matching the board to the specifications assigned to that particular model, thereby ensuring that the specifications have been met. However, the surface mount process involves conditions unsuitable for conventional labels. The circuit boards are subjected to baking cycles at temperatures of 450° F. and above, as well as immersion in and exposure to high pressure sprays of a variety of strong solvents. Conventional labels constructed of facestocks made from paper, polyester or polyvinyl chloride have been found to be severely limited in their ability to retain label integrity under these environmental constraints. Label curling, shrinkage, lifting, loss of scanability and related problems are frequently encountered obstacles.

Pressure sensitive tapes are used for masking printed circuit boards at the high temperatures associated with wave soldering and solder flux reflow board assembly operations. Masking prevents undesirable contamination of circuit boards by solder used to make electrical connections. It is known, for example, to achieve such masking by use of self-adhesive tapes based on high temperature resistant polyimide films coated with a silicone-based adhesive.

Labels and tapes utilizing high temperature resistant polymer films as facestock, e.g., films that will withstand temperatures of at least 500° F. indefinitely such as polyimides and polysulfones, have been commercially available since about 1983. Examples of such commercially available films include Stabar S100™ made from Victrex® polyethersulfone polymer and K200™ composed of non-crystallized, non-oriented polyether ketone, available from ICI of Wilmington, Del., and Kapton® polyimide films available from DuPont of Wilmington, Del. Such films, however, can be relatively expensive. Therefore, a low cost alternative for these high temperature films is desired.

### SUMMARY OF THE INVENTION

The present invention is directed to a high temperature resistant film particularly suitable for label applications and masking tape applications. The polyvinylidene fluoride (PVDF) film of the present invention maintains its integrity notwithstanding exposure to a variety of solvents frequently encountered in printed circuit board processing. The high temperature resistant film is constructed of a facestock film comprising at least one polyvinylidene fluoride polymer and a print receptive layer on the facestock film comprising a polymeric binder matrix and particles dispersed within the matrix.

The present invention is further directed to a high temperature resistant adhesive article constructed of a facestock film comprising at least one polyvinylidene fluoride polymer; a print receptive layer on a first surface of the facestock film, wherein the print receptive layer comprises a polymeric binder matrix and particles dispersed within the matrix; and a pressure sensitive adhesive layer adhered to the second surface of the facestock film.

Additionally, the present invention is directed to a method of producing the thermally stable film described above. The method includes the steps of: (a) providing a carrier film; (b) applying a curable print receptive coating composition onto the carrier film, the print receptive coating composition comprising a polymeric binder matrix and particles dispersed within the matrix; (c) curing the print receptive coating composition to form a print receptive layer; (d) applying a curable polyvinylidene fluoride polymer composition onto the print receptive layer, the polyvinylidene fluoride polymer composition comprising at least one polyvinylidene polymer; (e) curing the polyvinylidene fluoride polymer composition to form a polyvinylidene fluoride layer; and (f) removing the carrier layer.

The following description and annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings, which are not necessarily to scale:

FIG. 1 is a cross-sectional view of a label of the present invention.

FIG. 2 is a cross-sectional view of one embodiment of the method of making a label of the present invention.

### DETAILED DESCRIPTION OF THE INVENTION

The film of the present invention may be used for pressure sensitive applications such as labeling printed circuit boards, as well as for automotive, aerospace, medical and manufacturing applications where high temperature and solvent resistance are needed. As used herein, high temperature resistance means that the film is able to withstand exposure to a temperature of 300° C. for 5 minutes without burning, bubbling or becoming tacky.

PVDF

The thermally stable film is made of at least one polyvinylidene fluoride polymer. In one embodiment, the polyvinylidene fluoride-based polymers used to form the polyvinylidene fluoride-based films are known commercial products available from Elf Atochem North America under the KYNAR® trademark and from other producers worldwide. See, for example, “Vinylidene Fluoride Polymers”, Encyclopedia of Polymer Science and Engineering, Vol. 17, 2^{nd} Ed., page 532, 1989, John Wiley. The polyvinylidene fluoride polymer may be a homopolymer or any of its known copolymers or terpolymers with tetrafluoroethylene, chlorotrifluoroethylene, hexafluoropropylene and the like monomers.

Particularly useful commercially available polyvinylidene fluoride polymers include Kynar 2821, a polyvinylidene fluoride/hexafluoropropylene copolymer air milled to a dispersion grade particle size; Kynar 500 plus, a dispersion grade polyvinylidene fluoride homopolymer; Kynar 2500 Super Flex polyvinylidene fluoride/hexafluoropropylene copolymer resin; and Kynar 301F, a dispersion grade polyvinylidene fluoride homopolymer.

Admixtures of certain non-fluorine-based polymers used to form the polyvinylidene fluoride polymers to improve properties of films based on the polyvinylidene fluoride polymers, particularly pigmented films, are known (see U.S. Pat. No. 3,340,222). The acrylic polymer alloys with the polyvinylidene fluoride horrio and copolymers to form the polyvinylidene fluoride-based polymers contemplated by the invention and the formation of polyvinylidene fluoride polymer-based films therefrom by casting or extrusion are also well known. Examples of such acrylic polymers include ELVACITE 2008 and ELVACITE 2043 from ICI, and Acryloid B-44 from Rohm & Haas.

The polyvinylidene fluoride-based polymer may contain one or more high temperature resistant pigments. Such pigments include those pigments capable of withstanding a processing temperature of at least 600° F. In one embodiment, rutile titanium dioxide that has been surface treated with aluminum hydroxide and amorphous silica is added to the polyvinylidene fluoride polymer.

In addition to pigments, the PVDF film layer may contain other additives known to be stable at the required temperature, including dispersants, antioxidants, solvents and other conventional additives that may be used in such amounts as are known in the art.

Print Receptive Layer

The high temperature film of the invention includes a print receptive coating on its upper surface. The print receptive coating receives printed matter such as machine readable bar codes, alphanumeric identification and/or other identifying information by thermal transfer, laser, ink jet, flexographic, and dot-matrix printing. The print receptive coating is particularly suitable for thermal transfer printing.

For use in certain printed circuit board manufacturing applications, the high-temperature film of the invention may include a print receptive coating designed to resist extreme solvent and/or abrasion exposure, and preferably also demonstrate excellent resistance to harsh fluxing, wave solder environments and print smearing.

The print receptive coating generally comprises a binder resin and particulate matter. A wide variety of specific compounds may be used as the particulate matter, including silicates such as magnesium, calcium, hydrated aluminum and potassium aluminum silicate and other compounds such as magnesium oxide, silicon dioxide and calcium carbonate.

In one embodiment, the print receptive coating comprises a resin and conductive particles dispersed therein to impart antistatic properties to the high temperature film. The conductive particles dispersed within the binder resin may be selected from (a) metal or metal-coated particles; (b) carbon or graphite particles; (c) inorganic oxide particles with a conductive shell, commonly known as core-shell electroconductive pigments; and (d) conductive polymers in either particle or an interconnected network form. These particles are described in U.S. Pat. No. 5,441,809, which is incorporated herein by reference. Other antistatic agents include polyacetylenes, polyanilines, polythiophenes and polypyroles. These antistatic agents are described in U.S. Pat. Nos. 4,237,194 and 5,370,981. Typically, the conductive particles comprise at least about 30% by weight of the combined weight of the binder resin and the conductive particles. In one embodiment, the conductive particles comprise at least about 40% by weight, and in another embodiment, at least about 50% by weight of the combined weight of the binder resin and the conductive particles.

Preferred conductive particles are the core-shell particles having a nonconductive core, usually an oxide or mineral particle, and a thin outer shell of a conductive material. Examples of such conductive particles include the Zelec brand of conductive pigments commercially available from Milliken Chemical of Spartanburg, S.C., in which the core is a titanium dioxide particle, mica flake or silica sphere and the conductive outer shell is antimony doped tin oxide. Zelec ECP 2703-S is a preferred conductive particle.

The binder of the print receptive coating may comprise an alkyl acrylate or methacrylate polymer. In one embodiment, the binder comprises Elvacite 2041, a methyl methacrylate polymer.

The thickness of the print receptive layer is generally within the range of about 0.4 microns to about 10 microns. In one embodiment, the print receptive layer is within the range of about 0.5 to about 2.0 microns. In another embodiment, the thickness of the print receptive layer is about 1 micron.

Labels and Tapes

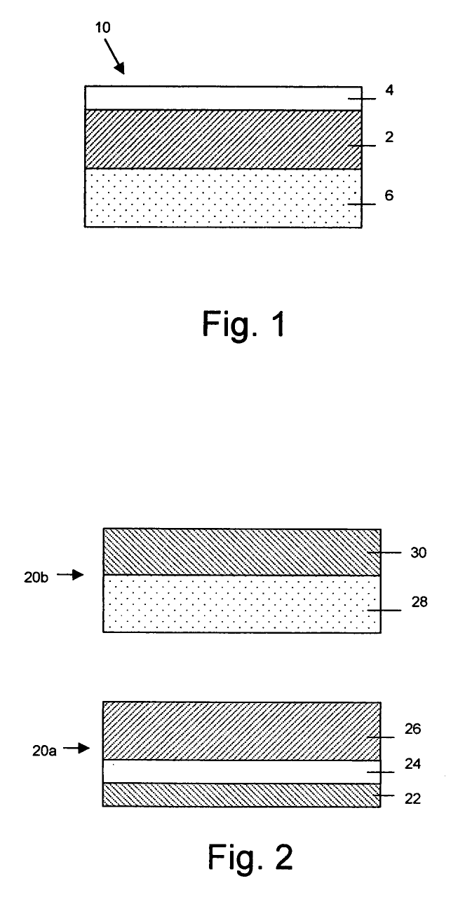

The thermally stable film of the present invention may be used to produce adhesive articles such as labels and tapes. One embodiment of a label of the invention is described by reference to FIG. 1. The illustrated label 10 comprises a thermally stable PVDF facestock film 2 having a thin print receptive layer 4 on its upper surface and having an adhesive layer 6 adhered to its lower surface. Print receptive layer 4 facilitates the printing of information on the surface of label 10.

Adhesive

The adhesive applied to the thermally stable facestock film may be a removable adhesive or a permanent adhesive. The adhesive generally should be able to withstand exposure to high temperatures, e.g., up to 600° F., for 2-3 minutes.

Acrylic, silicone and rubber based pressure sensitive adhesives are representative of the various types of adhesives that can be used in this invention, but for reasons of temperature stability and high shear strength, the acrylic-based adhesives are preferred. Pressure sensitive adhesives based on acrylic and/or methacrylic ester based monomers, a glycidyl monomer and a N-vinyl lactam monomer, such as those described in U.S. Pat. No. 4,812,541, which is hereby incorporated by reference herein, are particularly useful acrylic-based adhesives.

High temperature silicone-based pressure sensitive adhesives, such as those described in U.S. Pat. Nos. 5,096981; 5,441,811 and 5,506,288, which are hereby incorporated by reference herein, and those commercially available from General Electric Company, may be used in the present invention.

Removable adhesives allow for repositioning of the label or tape after it has been secured to the surface of, for example, an electronic component. Examples of removable acrylic adhesives include Polytac 415, 301 and 351 from H & N Chemicals.

The adhesive may be coated directly onto the surface of the thermally stable film by any known method, including knife coating, Meyer bar coating, extrusion die and other conventional means known in the art for coating adhesives. In one embodiment, the adhesive is laminated to the thermally stable film by using a transfer tape made up of an adhesive layer and a liner. For example, a transfer tape such as FasTape™ 1182 UHA from Fasson, an acrylic adhesive on an 80 lb. densified Kraft release liner, may be used to apply the adhesive to the thermally stable film.

The thickness of the adhesive layer is generally within the range of about 0.5 mil to about 2.5 mils. In one embodiment, the thickness of the adhesive layer is about 1 mil to about 2.0 mils.

Manufacturing Process

In general, the method of manufacturing the high temperature film of the present invention comprises the steps of: (a) providing a carrier film; (b) applying a curable print receptive coating composition onto the carrier film, the print receptive coating composition comprising a polymeric binder matrix and particles dispersed within the matrix; (c) curing the print receptive coating composition to form a print receptive layer; (d) applying a curable polyvinylidene fluoride polymer composition onto the print receptive layer, the polyvinylidene fluoride polymer composition comprising at least one polyvinylidene polymer; (e) curing the polyvinylidene fluoride polymer composition to form a polyvinylidene fluoride layer; and (f) removing the carrier layer.

In one embodiment of the invention, the high temperature film is prepared by coating a polyester film carrier, such as polyethylene terephthalate, with a thin layer of a print receptive coating. The print receptive coating may be applied by any suitable method, including gravure cylinder, reverse gravure, Meyer rods, slot dye, spray coating. The print receptive coating is then dried.

The polyvinylidene fluoride layer is then applied to the print receptive coating. The polyvinylidene fluoride layer may be applied by any suitable method, including slot die coating. The polyvinylidene fluoride layer is then dried at temperatures up to about 360° F. The thickness of the polyvinylidene fluoride layer is generally in the range of about 1 mil to about 3 mils. In one embodiment, the thickness of the polyvinylidene fluoride layer is in the range of about 1.5 mils to about 2.0 mils.

For adhesive articles, a pressure sensitive adhesive is then applied to the outer surface of the polyvinylidene fluoride layer. In one embodiment, the adhesive is applied by laminating a pressure sensitive adhesive on a supporting liner to the polyvinylidene fluoride layer. The carrier film is then removed from the adhesive article.

### EXAMPLE 1

A white, thermally stable PVDF film was made by first applying a thin layer of print receptive coating onto a 1.42 mil PET carrier film by doctored gravure cylinder. The print receptive coating was prepared from the following formulation:

Print Receptive Coating 1

| Ingredients | Parts by Weight |
|---|---|
| toluene | 58.54 |
| MIBK | 21.46 |
| Zelec ECP 2703-S | 12.20 |
| Elvacite 2041¹ | 7.80 |

¹polymethyl methacrylate polymer

The Elvacite 2041 acrylic resin and Zelec ECP 2701-S conductive pigment were mixed with the solvents under heat applied at approximately 130° F. to dissolve the acrylic resin in the solvent. The batch was then allowed to cool.

After the print receptive coating was applied to the PET carrier and dried in a forced air oven, the PVDF color layer was applied using a slot die coater. The PVDF color layer was prepared from the following formulation:

PVDF Color Composition 1

| Ingredients | Parts by Weight |
|---|---|
| cyclohexane | 16.06 |
| Exxate 700¹ | 10.70 |
| Butyrolactone | 16.06 |
| Kynar 2500 Superflex | 10.70 |
| Solsperse 17000² | 0.10 |
| Kynar 500 Plus | 24.98 |
| cyclohexane | 4.46 |
| Exxate 700 | 5.35 |
| Butyrolactone | 8.03 |
| R960 Dispersion | 3.57 |

¹acetate type solvent, Exxon Corporation
²dispersing aid, Zeneca Corporation

The first three solvents were preblended in a vessel. The Kynar 2500 PVDF polymer and Solsperse 17000 were then added to the vessel with mixing at a high speed until the Kynar 2500 was dissolved. The mixture was then cooled to about room temperature (65-85° F.) and then Kynar 500 was added with high speed mixing and at a temperature not exceeding 105° F. A preblend of cyclohexane, Exxate 700, butyrolactone and the R960 Dispersion was then prepared and added to the batch. The R960 Dispersion was prepared from the following formulation:

R960 Dipersion

| Ingredients | Parts by Weight |
|---|---|
| Exxate 700 | 24.38 |
| Butrolactone BLO | 8.12 |
| Elvacite 2008¹ | 7.50 |
| Ti Pure R960 TiO₂ | 60.00 |

¹polymethyl methacrylate, ICI Corporation

The PVDF film was fused and dried in a multi-zone forced air drying oven at temperatures up to about 360° F.

### EXAMPLE 2

A white, thermally stable PVDF film was made substantially in accordance with the procedure described in Example 1, with the exception that the PVDF color layer was prepared from the following formulation:

PVDF Color Composition 2

| Ingredients | Parts by Weight |
|---|---|
| Exxate 700 | 29.86 |
| Butyrolactone BLO | 9.95 |
| Solsperse 17000 | 0.21 |
| Kynar 2821 LV¹ | 53.08 |
| R960 Dispersion | 6.90 |

¹air milled to dispersion grade particle size

The two solvents were preblended in a vessel. The Kynar 2821 LV and Solsperse 17000 were added to the vessel with high speed mixing. The R960 dispersion was then added with high speed mixing until the Kynar resin was uniformly dispersed.

The PVDF film of the invention may be used to prepare high temperature resistant labels. In one embodiment, illustrated in FIG. 2, a first label component 20a comprises carrier film 22, onto which a print receptive layer 24 is applied. PVDF film 26 overlies the print receptive layer 24. A second label component 20b is comprised of pressure sensitive adhesive layer 28 adhered to a removable release liner 30. To prepare a label, pressure sensitive adhesive layer 28 is laminated to the upper surface of PVDF layer 28. The carrier film 22 may then be removed from the print receptive layer 24.

In one embodiment, an acrylic based permanent adhesive on a removable release liner is laminated to the PVDF layer.

The label of the invention may be provided without any printed matter on the label for on-demand printing applications. Alternatively, the label may be provided with printed matter already applied to the print receptive layer 24 of the label. The printed matter should provide contrast to the print receptive/PVDF layers and should be heat and solvent resistant.

The films of Examples 1 and 2 were tested for chemical resistance by printing barcodes onto the print receptive layer of the film using a Zebra 170Xii thermal transfer printer. The films were allowed to dwell for 24 hours. The resistance to the organic solvents organo flux, isopropyl alcohol and halide free flux for each film was tested. A small nylon brush dipped in the chosen organic solvent was brushed across the film. The number of brush strokes required to damage the printed matter or the film was recorded. While minimal damage to the printed matter is acceptable, the printed matter must remain legible and the barcodes scanable. One hundred brush strokes without significant damage is required to pass the chemical resistance test.

The films of the invention were tested for heat resistance by heating the films of Examples 1 and 2 to a temperature of 300° C. for 5 minutes. The films did not exhibit any bubbling or distortion.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

What is claimed is:

1. A high temperature resistant film comprising:
a facestock film having a first major surface and a second major surface and comprising at least one polyvinylidene fluoride polymer; and
a print receptive layer on the first major surface of the facestock film wherein the print receptive layer comprises a polymeric binder matrix and particles dispersed within the matrix.

2. The high temperature resistant film of claim 1 wherein the polyvinylidene fluoride polymer comprises a copolymer of polyvinylidene fluoride and hexafluoropropylene.

3. The high temperature resistant film of claim 1 wherein the facestock film comprises a polyvinylidene homopolymer and a copolymer of polyvinylidene fluoride and hexafluoropropylene.

4. The high temperature resistant film of claim 1 wherein the facestock film further comprises a dispersed pigment.

5. The high temperature resistant film of claim 1 wherein the facestock film further comprises an acrylic polymer.

6. The high temperature resistant film of claim 1 wherein the polymeric binder matrix of the print receptive layer comprises an acrylic polymer.

7. The high temperature resistant film of claim 1 wherein the particles dispersed within the matrix comprise conductive particles.

8. The high temperature resistant film of claim 7 wherein the conductive particles comprise a conductive pigment.

9. The high temperature resistant film of claim 1 wherein the thickness of the facestock film is about 1 mil to about 3 mils.

10. The high temperature resistant film of claim 1 wherein the thickness of the print receptive layer is about 0.4 microns to about 10 microns.

11. The high temperature resistant film of claim 1 wherein the high temperature resistant film is capable of maintaining printed matter legibly and optical scanability after being heated to a temperature of 300° C. for 5 minutes and contacted with organic solvents.

12. A high temperature resistant adhesive article comprising:
a facestock film having a first major surface and a second major surface and comprising at least one polyvinylidene fluoride polymer;
a print receptive layer on the first major surface of the facestock film wherein the print receptive layer comprises a polymeric binder matrix and particles dispersed within the matrix; and
a pressure sensitive adhesive layer adhered to the second major surface of the facestock film.

13. The high temperature resistant adhesive article of claim 12 wherein the polyvinylidene fluoride polymer comprises a copolymer of polyvinylidene fluoride and hexafluoropropylene.

14. The high temperature resistant adhesive article of claim 12 wherein the facestock film comprises a polyvinylidene homopolymer and a copolymer of polyvinylidene fluoride and hexafluoropropylene.

15. The high temperature resistant adhesive article of claim 12 wherein the facestock film further comprises a dispersed pigment.

16. The high temperature resistant adhesive article of claim 12 wherein the facestock film further comprises an acrylic polymer.

17. The high temperature resistant adhesive article of claim 12 wherein the polymeric binder matrix of the print receptive layer comprises an acrylic polymer.

18. The high temperature resistant adhesive article of claim 12 wherein the particles dispersed within the matrix comprise conductive particles.

19. The high temperature resistant adhesive article of claim 18 wherein the conductive particles comprise a conductive pigment.

20. The high temperature resistant adhesive article of claim 12 wherein the thickness of the facestock film is about 1 mil to about 3 mils.

21. The high temperature resistant adhesive article of claim 12 wherein the thickness of the print receptive layer is about 0.4 microns to about 10 microns.

22. The high temperature resistant adhesive article of claim 12 wherein the adhesive article film is capable of maintaining printed matter legibly and optical scanability after being heated to a temperature of 300° C. for 5 minutes and contacted with organic solvents.

23. The high temperature resistant adhesive article of claim 12 wherein the pressure sensitive adhesive comprises a permanent adhesive.

24. The high temperature resistant adhesive article of claim 12 wherein the pressure sensitive adhesive comprises a removable adhesive.

25. The high temperature resistant adhesive article of claim 23 wherein the pressure sensitive adhesive comprises an acrylic based adhesive.

26. A method of manufacturing a high temperature film comprising the steps of:
providing a carrier film;
applying a curable print receptive coating composition onto the carrier film, the print receptive coating composition comprising a polymeric binder matrix and particles dispersed within the matrix;
curing the print receptive coating composition to form a print receptive layer;
applying a curable polyvinylidene fluoride polymer composition onto the print receptive layer, the polyvinylidene fluoride polymer composition comprising at least one polyvinylidene fluoride polymer;
curing the polyvinylidene fluoride polymer composition to form a polyvinylidene fluoride layer; and
removing the carrier layer.

27. The method of claim 26 wherein the print receptive coating composition comprises a polymeric binder matrix, conductive pigment dispersed within the matrix and at least one solvent.

28. The method of claim 26 wherein the polyvinylidene fluoride polymer composition comprises at least one polyvinylidene fluoride polymer, at least one pigment, and at least one solvent.

29. The method of claim 26 wherein the polyvinylidene fluoride polymer composition comprises a polyvinylidene fluoride homopolymer and a copolymer of polyvinylidene fluoride and hexafluoropropylene.
